(19) United States
(12) Patent Application Publication
(10) Pub. No.: US 2014/0366327 A1
(43) Pub. Date: Dec. 18, 2014

(54) REPLACEABLE GRIP AND APPARATUS AND METHOD THEREFOR

(71) Applicant: Ben Huang, Huntington Beach, CA (US)

(72) Inventor: Ben Huang, Huntington Beach, CA (US)

(21) Appl. No.: 13/916,519

(22) Filed: Jun. 12, 2013

(51) Int. Cl. B25G 1/10; B25G 3/34

(52) U.S. Cl. CPC B25G 1/10; B25G 3/34; B29L 2031/463
USPC 16/421; 29/428; 29/426.1; 156/293

(57) ABSTRACT

Disclosed are grips and apparatuses and methods of replacing or installing grips on the handle of an article, and in particular for use with golf clubs, fishing poles, bicycle handles, hand tools, etc. Embodiments may include a grip portion and an adaptor butt configured to secure the grip portion to the handle portion of an article.

### INCORPORATION BY REFERENCE

The present application hereby incorporates by reference in their entireties the following U.S. Patents and Publications: U.S. Pat. Nos. 8,201,357, 8,424,236, and U.S. Patent Publication Nos. 2010/0260987 and 2011/0113673.

### BACKGROUND OF THE INVENTION

1. Field of the Invention

Embodiments relate to an improved grip replacement apparatus and method for use with the handle portion of articles, in particular, the handle portion of fishing poles, golf clubs, bicycle handles, hand tools, etc.

2. Description of the Related Art

The grips used for various activities wear out over time. Some methods have been developed for replacing grips.

Most modern grips have retained a historical cylindrical design. In addition, many grips are made of cork, as cork is light, durable, and transmits rod vibrations fairly well. However, cork is also a fairly hard material, which may be uncomfortable to hold during a long fishing trip. EVA and PVC foams are consequently used in place of cork, but grips incorporating these foams also tend to be stiff and uncomfortable to hold for long periods of time. The stiffness and shape of currently available grips can cause strain on the hands and arms. This is particularly evident as fishers often hold a fishing pole for a long period of time. In some instances, such as in deep sea fishing, fishers may hold the rod for a significant number of minutes or even hours. In addition, fighting a fish can also cause strain. Some fish, such as sharks, are heavy and fight long and vigorously. Moreover, people fish in many different environments that may contribute to further strain. Ice fishers, for example, fish in frigid temperatures that may cause already stiff grips to feel even stiffer.

Thus, there remains a need for a replacement grip apparatus and replacement method to replace worn out grips or to simply replace undesirable grips with better functioning options

### SUMMARY OF THE INVENTION

Disclosed herein, according to some embodiments, is a grip assembly for the handle portion of an article, the grip assembly including a grip portion, an adaptor, and an adaptor butt. The grip portion is generally defined by a hollow interior shaft open at both a proximal end and a distal end of the grip portion. The adaptor is configured to secure, at a distal end of the adaptor, to a proximal end of a shaft of the handle portion. The adaptor butt is configured to engage a proximal end of the adaptor, and the adaptor butt is further configured to engage the proximal end of the grip portion.

In some embodiments, a grip assembly includes an adhesive that is used to secure the adaptor to the proximal end of the shaft. Some embodiments include threads on at least one of the adaptor butt and the adaptor. The threads may be used in a threaded engagement for engaging the adaptor butt to the adaptor.

According to some embodiments of a grip assembly, the distal end of the grip portion is configured to engage an element on the handle portion of the article. The distal end of the grip can additionally include a stepped configuration insertable within an end of the element on the handle portion of the article. In some cases, the element on the handle portion of the article is a finger hook.

In some embodiments, a grip assembly also includes a distal cap, the distal cap having a hollow shaft portion and an exterior portion configured to engage the distal end of the grip portion. The distal cap may be shaped to provide a generally smooth transition between the handle and the distal end of the grip portion. The generally smooth transition may comprise a sloped configuration in the general shape of a frustoconical cone. Alternatively, the smooth transition may comprise a cylindrical configuration configured to further engage with an element on the handle portion.

Also disclosed herein, according to some embodiments, is a method of installing a grip assembly on a handle portion of an article, the method including sliding a grip portion onto a shaft of the handle portion, securing an adaptor to a proximal end of the shaft of the handle portion, and affixing an adaptor butt to a proximal end of the adaptor. The grip portion can generally be defined by a hollow interior shaft open at both a proximal end and a distal end of the grip portion. The adaptor butt can also be configured to engage the proximal end of the grip portion.

Some methods further include sliding a distal cap onto the shaft of the handle portion and securing the distal end of the grip portion to a proximal end of the distal cap. The distal cap can be configured to provide a smooth transition between the distal end of the grip portion and the handle portion of the article. In some embodiments, an adhesive is used between an interior surface of the adaptor and an exterior surface of the shaft. According to some embodiments, a preexisting grip is first removed from the handle portion of the article.

Also disclosed herein, according to some embodiments, is a method of installing a grip assembly on a handle portion of an article, the method including sliding a grip portion onto a shaft of the handle portion, securing an adaptor to a proximal end of the shaft of the handle portion, affixing an adaptor extension to the proximal end of the adaptor, and affixing an adaptor butt to the proximal end of the adaptor extension. The grip portion may be generally defined by a hollow interior shaft open at both a proximal end and a distal end of the grip portion. The adaptor portion may be defined by a hollow interior shaft open at both a proximal end and a distal end of the adaptor. The adaptor extension may be defined by a hollow interior shaft open at both a proximal end and a distal end. And the adaptor butt can be configured to engage the proximal end of the grip portion.

In some embodiments, an installation method also includes sliding a distal cap onto the shaft of the handle portion and securing the distal end of the grip portion to a proximal end of the distal cap. The distal cap may be configured to provide a smooth transition between the distal end of the grip portion and the handle portion of the article. In some embodiments, an adhesive may be used between an interior surface of the adaptor and an exterior surface of the shaft to secure the adaptor to the shaft. It may be necessary, in some cases, to remove a preexisting grip from the handle portion of the article. In some embodiments, the size of the adaptor extension is determined based on the size of the grip portion and the size of the handle portion, for example a longer adaptor extension may be used where the size of the grip portion greatly exceeds the size of the handle portion.

Embodiments include one or more advantages including offering replacement grips having better feel, color, and/or design than grips included with products when first purchased. Embodiments can also include easier replacement of worn or undesirable grips. In the context of fishing pole grips, replacement allows a user to keep the same rod rather than replace the entire rod when the grip wears out. Replacement using the presently disclosed grips and apparatuses also overcomes some of the drawbacks of currently available grips. Utilizing the presently disclosed methods, apparatuses, and grips can provide a superior grip having improved tackiness and cushioning.

In some embodiments, a replaceable grip comprises a lightweight material that readily dries off if exposed to water. The replaceable grip can include different surface materials to provide different levels of tackiness and/or different cushioning in distinct areas of the grip

In addition, some embodiments permit the use of multiple materials as desired. For example, some embodiments may incorporate more durable materials in areas of high wear. In some embodiments, a cap structure can be used at the closed end of the grip that facilitates the incorporation of different materials at such end. In some embodiments, a resilient material is used that is preferably stronger and denser than the EVA used in the majority of the sleeve of some embodiments.

In various embodiments, a fishing pole includes a rod having a proximal end and a distal end, where the proximal end receives a grip and the distal end directs a fishing line. The grip of some embodiments includes a replaceable assembly and a flexible mounting tube that engages the proximal end of the rod and a sheet including an outside layer comprising a polymer and an inside layer. In some embodiments, the sheet has a configuration corresponding to the exterior shape of the flexible mounting tube, being wrapped about and adhered to the mounting tube, with the side edges of the sheet abutting one another to define a longitudinal seam. In some embodiments, the outside layer further comprises one or more fabric layers. In some embodiments, the inside layer comprises EVA.

Various implementations of a grip for a fishing pole include a flexible mounting tube configured to engage an end of a rod and a sheet that includes a polymer outside layer and an inside layer. The sheet of certain embodiments has a configuration corresponding to the exterior shape of the flexible mounting tube, being wrapped about and adhered to the mounting tube. In some embodiments, the grip is part of an assembly that can be configured to be selectively removed from a fishing pole.

Some embodiments provide a grip configured for use with at least a portion of the handle portion of an article, the grip comprising an ethylene vinyl acetate sleeve including a first end, a second end, and a mounting surface extending generally therebetween and a gripping member. In some embodiments, the gripping member comprises an ethylene vinyl acetate inner layer and an outer layer comprising polyurethane, the inner layer of the gripping member being adhered to the mounting surface of the sleeve. In some embodiments, the article is a fishing pole.

Some embodiments provide a method of manufacturing a sleeve for use with a grip, the method comprising the steps of injection molding a primary form of the sleeve in a first mold, the primary form of the sleeve comprising ethylene vinyl acetate. In some embodiments, the injection molded primary form of the sleeve is then removed from the first mold and a core bar is inserted into the inner cavity of the primary form of the sleeve. In some embodiments, the core bar and the primary form of the sleeve are inserted into additional tooling machinery to allow for control of the temperature and time spent at the one or more temperatures to control the coagulation of the ethylene vinyl acetate such that the finished ethylene vinyl acetate as at least approximately one half as dense as the ethylene vinyl acetate injected into the primary form.

### BRIEF DESCRIPTION OF THE DRAWINGS

Further objects, features and advantages of the inventions will become apparent from the following detailed description taken in conjunction with the accompanying figures showing illustrative embodiments, in which:

FIG. 1 is a perspective view of a fishing pole incorporating a replaceable grip assembly according to certain embodiments;

FIG. 2 is an exploded side view of an embodiment of a replaceable grip and a portion of a fishing pole shaft;

FIG. 3 is a sectioned side view of the embodiment shown in FIG. 2;

FIG. 4 is a sectioned side view of another embodiment illustrating the distal portion of a replaceable grip assembly;

FIG. 5 is a sectioned side view of still another embodiment illustrating the distal portion of a replaceable grip assembly;

FIG. 6 is a sectioned side view of another embodiment illustrating the butt portion of a replaceable grip assembly;

FIG. 7 is a perspective view of a fishing pole incorporating a replaceable grip assembly according to additional embodiments;

FIG. 8 is an exploded side view of an embodiment of a replaceable grip and a portion of a fishing pole shaft;

FIG. 9 is a sectioned side view of the embodiment shown in FIG. 8;

FIG. 10 is an enlarged sectioned side view of a portion of the grip of a telescoping pole;

FIG. 11 illustrates a method of installing a grip assembly;

FIG. 12 illustrates a method of removing a grip and installing a replacement grip;

FIG. 13 illustrates a method of installing a grip assembly using an adaptor extension.

While embodiments will now be described in detail with reference to the figures, it is intended that changes and modifications can be made to the described embodiments without departing from the true scope and spirit of the disclosure herein.

### DETAILED DESCRIPTION OF THE PREFERRED EMBODIMENT

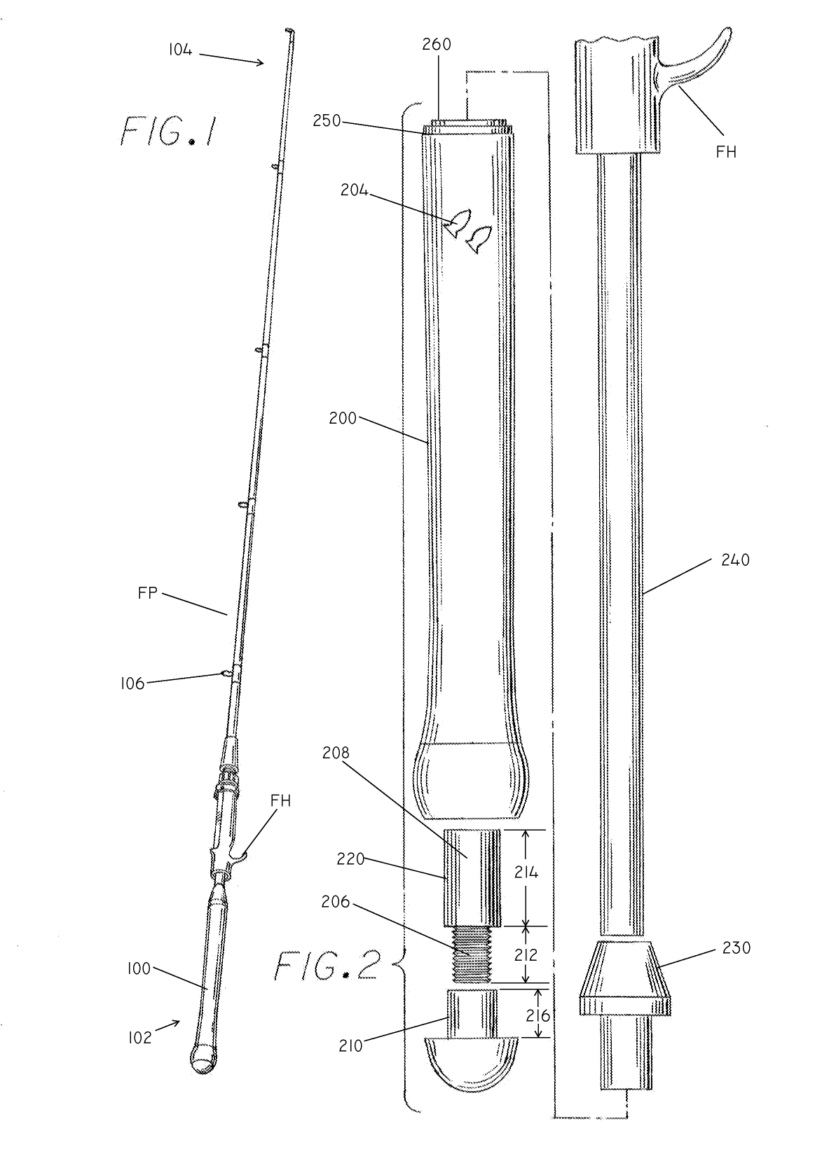

Referring to the drawings, in FIG. 1 one embodiment of a replaceable grip assembly 100 is shown attached to a shaft of a fishing pole FP having a proximal end 102 and a distal end 104. The fishing pole FP may include one or more line guides or rings 106 for receiving fishing line (not shown). Though not shown, a reel R may also be attached to the fishing pole FP. In use, a fishing line will typically extend through the line guides 106 and beyond the distal end 104 of the fishing pole FP.

Turning now to FIG. 2, Embodiments of the replaceable grip assembly 100 include a main grip portion 200 having an adaptor butt 210 secured at the proximal end and, secured at the distal end, a distal cap 230. Grip portion 200 may include a sheet of material 250 wrapped around a mounting tube 260 or a number of sheets adhered together and then wrapped around a mounting tube.

In some embodiments, replacement grip assembly 100 comprises four components: adaptor butt 210, adaptor 220, the grip portion 200, and the distal cap 230. Each of these components may be aligned along a central axis generally corresponding to a central axis of a shaft 240 of the fishing pole FP. Adaptor butt 210, adaptor 220, and distal cap 230 (collectively, “adaptor pieces”) may comprise the same or different materials, such as one or more plastics or one or more polymers.

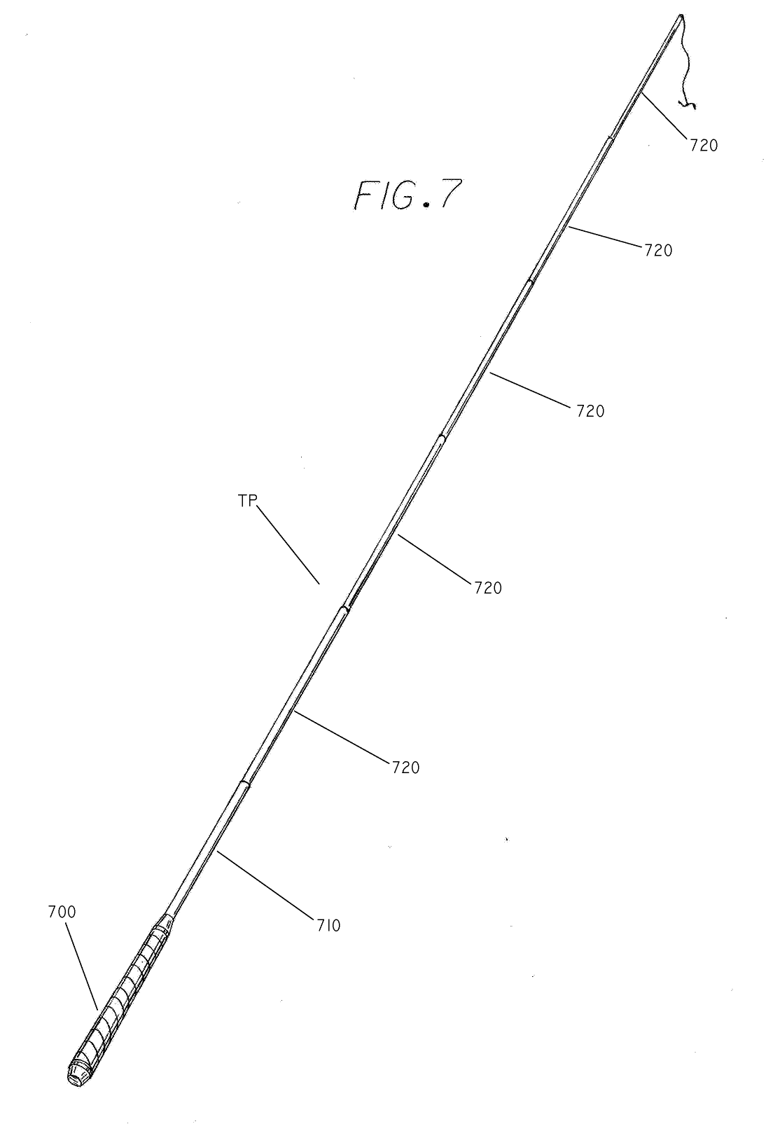

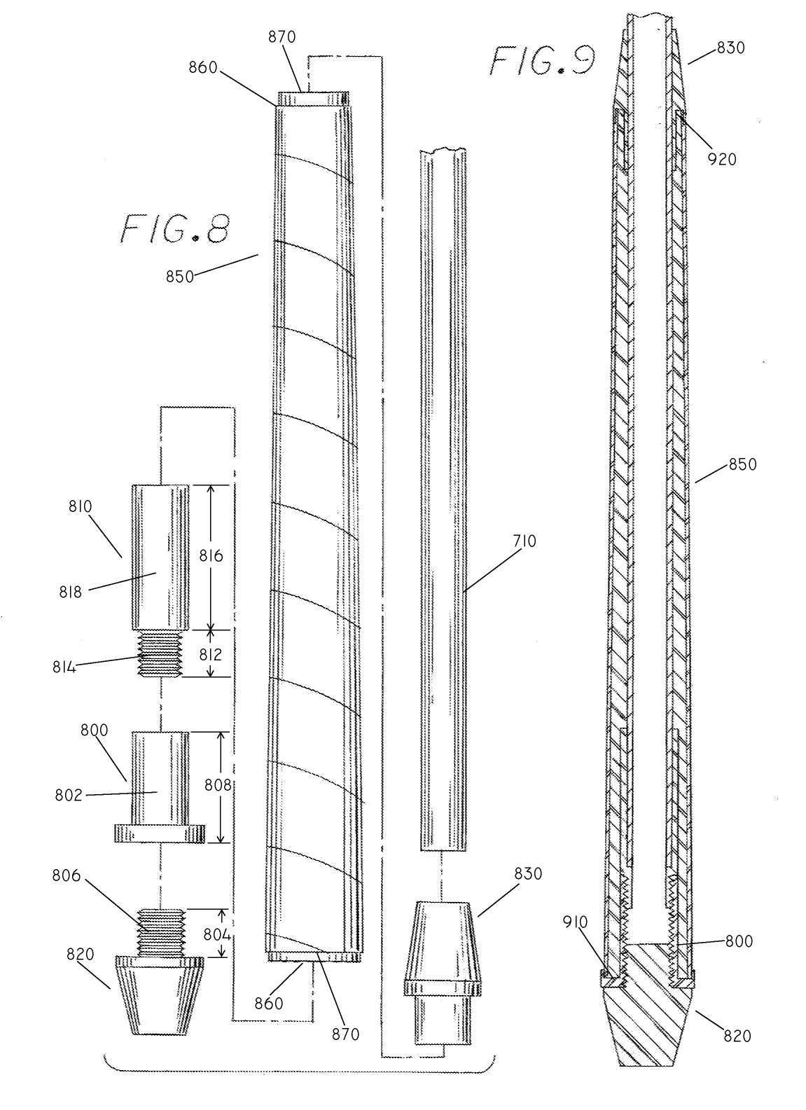

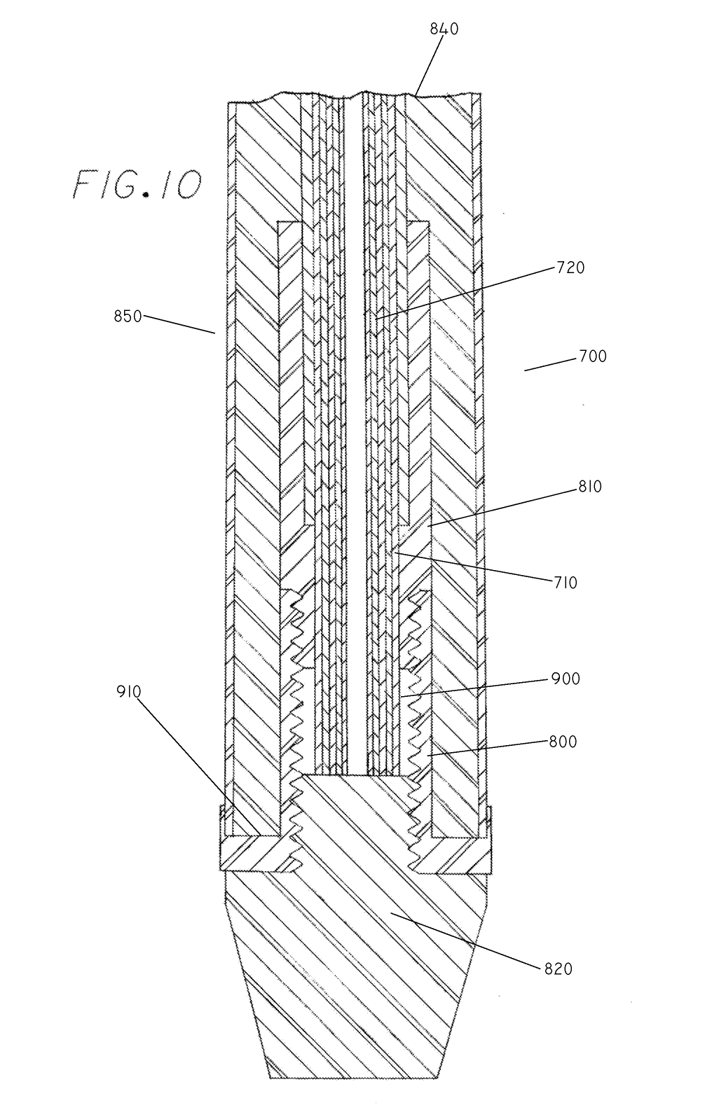

Grip portion 200 illustrated in FIG. 2 includes a gripping material, as illustrated as a sheet material 250 comprising a panel, wrapped around mounting tube 260. In some embodiments, alternative configurations are used, such as spiral wrapped materials. For example, the embodiment illustrated in FIGS. 7 and 8 includes a spiral wrapped material 860 that is wrapped around a mounting tube 870. This embodiment is discussed in greater detail below. The gripping material 250 is shown covering a substantial portion of the tube 260. In some embodiments, the gripping material is configured to cover all of the tube 260. In some embodiments, additional portions of the tube 260 remain exposed.

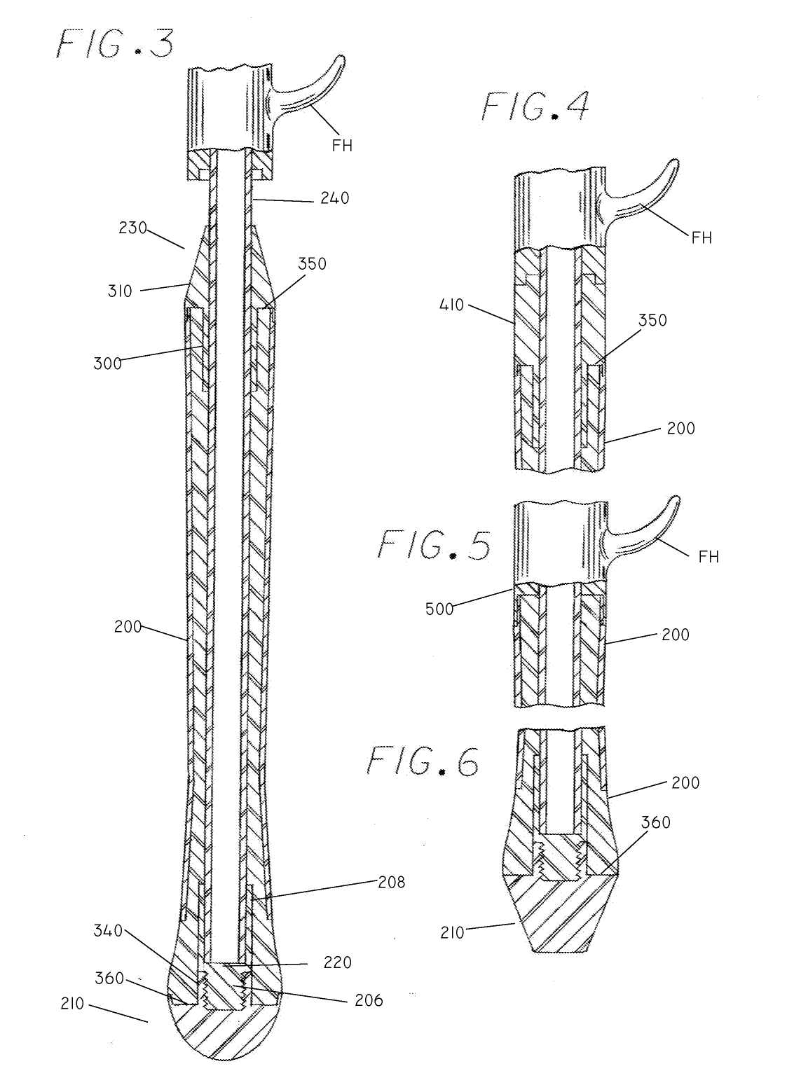

FIG. 3 illustrates a cross-section taken along the length of a grip assembly according to some embodiments. As illustrated, distal cap 230 comprises a hollow shaft portion 300 and a cap portion 310. Hollow shaft portion 300 may have an inner diameter equal to or larger than an outer diameter of the shaft 240. Because some shafts are not perfect cylinders but rather are widest at the base or butt end and taper toward the tip or distal end, the inner diameter of hollow shaft portion 300 may need to be as large as the outer diameter at the proximal end of shaft 240 so as to allow the distal cap 230 to be slid onto the shaft 240. Because of the tapered nature of many shafts, such as shaft 240, and the positioning of the distal cap 230 at a point distal to the widest portion of the shaft, there may be a gap (not shown) between the inner surface of the hollow shaft portion 300 of the distal cap 230 and the outer surface of the shaft 240. Such a gap may be left open or may be filled with a suitable material, such as an adhesive or a resilient material, such as rubber. It may be desirable to adhere the distal cap 230 to the grip portion 200.

The distal cap 230 can serve as a transition between the grip portion 200 and the shaft 240 or any elements on the shaft, such as a finger hook FH. In some embodiments, the distal cap 230 includes a recessed area 350 to receive the distal end of the grip portion 200. Cap portion 310 of the distal cap 230 may take any number of shapes depending on the type and size of rod used. For example, in some embodiments, cap portion 310 may comprises a frustoconical cone configured to taper from an outer diameter of the distal end of grip portion 200 to an outer diameter of the shaft 240. In some embodiments, cap portion 310 defines a slightly curved profile. In some embodiments, an outer surface of cap portion 310 is angled to correspond to a feature of the shaft or rod, such as reel R or finger hook FH. Thus, in some embodiment, cap potion 310 may even increase in diameter from the grip portion 200 to the distal end of the cap portion 310.

In some embodiments, the distal end of grip portion 200 has a stepped configuration, which may be achieved by any number of methods, such as heat compression, exposing a portion of the underlying mounting tube, etc. A stepped configuration may allow the distal end of grip portion 200 to be inserted into recessed area 350 of distal cap 230. For example, heat compression may be used to compress a width of the distal end that is equal to the depth of recessed area 350. In this way, a substantially smooth and/or substantially unitary appearance may be achieved at the juncture between grip portion 200 and distal cap 230.

According to some embodiments, the amount of insertion or the amount that a recessed area extends along a length of grip portion 200 may vary depending on the process used to accommodate the recess, the materials used for grip portion 200, the materials used for the grip assembly, etc. This feature may also be called a recessed depth. In some embodiments, the recessed depth is zero and the face of the grip 200 is configured to mate in a substantially fluid manner with the bottom face of the cap portion 310. In some embodiments, the recessed depth is greater than zero. In some embodiments, the recessed depth of recessed area 350 may be greater than about 1 millimeter. In some embodiments, recessed area 350 may be less than about 1 centimeter in depth. In some embodiments, the recessed depth of recessed area 350 may be between approximately 1 millimeter and approximately 3 millimeters. In some embodiments, recessed area 350 has a depth of about 2 millimeters.

Similarly, the recess depth of recessed area 360 of the adaptor butt 210 may be greater than about 1 millimeter. In some embodiments, recessed area 360 may be less than about 1 centimeter deep. Some embodiments may have a depth of from about 1 millimeter to about 3 millimeters. And some embodiments may have a recessed area 360 having a depth of about 2 millimeters.

FIGS. 4 and 5 illustrate at least some of the various profiles that may define a cap portion of a distal cap. For example, FIG. 4 demonstrates the cap portion 410 may be configured to interlock or substantially mate with a finger hook FH on the shaft 240 of the fishing pole FP. Other configurations are also possible and may be dictated by the shape of the receiving structure on the shaft 240 and desired aesthetics. Some embodiments may even do away with a distal cap 230, such as the embodiment shown in FIG. 5, in which the distal end 500 of the grip portion 200 is configured to interlock or substantially mate with a finger hook FH element on the shaft 240. This configuration may be achieved simply by using a longer grip portion, or it may suit a fishing pole having limited room for the handle area of the pole. Similarly, cap portion 410 may be larger to allow a smaller grip portion to accommodate a larger handle portion with the article to be gripped.

In some embodiments, the distal cap 230 may be adhered to the shaft 240, an element on the shaft 240 such as a finger hook FH, and/or the grip portion 200. An adhesive material (such as a paste, cream, liquid, or tape) could be applied to any number of surfaces of the distal cap 230, such as the inside surfaces of the hollow shaft portion 300, a proximal surface that mates with the grip portion 200, an outer surface parallel to the hollow shaft 300, or a distal surface that mates with an element on the shaft 240.

Returning to FIGS. 2 and 3, according to some embodiments, adaptor 220 comprises a male portion 206 and a hollow shaft portion 208. Hollow shaft portion 208 has an inner diameter that may be equal to or slightly larger than an outer diameter of the shaft 240. In some embodiments, it is desirable for the adaptor 220 to be secured to the proximal end of the shaft 240, and it may be desirable to modify the shaft 240 as little as possible or not at all. Accordingly, in some embodiments, the inner diameter of the hollow shaft portion 208 is larger than the outer diameter of the shaft 240. This configuration allows the adaptor 220 to be slid onto the shaft without modifying the shaft 240. If necessary, an adhesive or tape, such as a double-sided tape, may be used to enhance the fit between the shaft 240 and the adaptor 220. Depending the difference between the inner diameter of the hollow shaft portion 208 and the outer diameter of the shaft 240, more than one layer of adhesive or tape could be applied. In some embodiments, the inner diameter of the hollow shaft portion 208 is substantially equal to or slightly smaller than the outer diameter of the shaft 240. Thus, the adaptor 220 may also be adhered to the shaft 240 using only frictional forces between the material of the shaft 240 and the hollow shaft portion 208. In some embodiments, it may be desirable to reduce or taper the outer diameter of the shaft 240, such as, for example, by grinding or sanding, to better accommodate the shaft portion 208 or to create frictional forces between the shaft 240 and the adaptor 220.

Because the adaptor 220 may extend or increase the effective length of the shaft 240 and may provide support for the grip portion 200 and any forces applied to the grip portion 200, it is desirable that the adaptor 220 as well as the adaptor butt 210 exhibit sufficient strength. Material selection may be important as well as the dimensions chosen for each component. The dimensions of the various components can be thought of as ratios. Referring to the adaptor 220 and the adaptor butt 210, ratios may be based on the relationship between any number of suitable characteristics, such as the length 212 of the male portion 206, the length 214 of the hollow shaft portion 208, the length 216 of the hollow cylindrical body shaft 340, etc. In some embodiments, the ratio between lengths 212 and 216 is about 1:1, but can be as low as about 1:2. The ratio between lengths 212 and 214 is about 3:5, but can be anywhere between about 1:3 to about 3:2. Moreover, the ratio between lengths 214 and 216 is about 9:7 but can be anywhere from about 1:2 to about 4:1. Similarly, the ratio between the length of the grip portion 200 and the portion of the adaptor butt 210 inside the grip portion 200. (i.e., length 216) is about 14:1 or from about 4:1 to about 30:1.

FIG. 3 also illustrates the adaptor butt 210 attached to the adaptor 220 at the proximal end of the grip portion 200 and the shaft 240. In some embodiments, the adaptor butt 210 includes a hollow cylindrical body shaft 340 configured to mate with or attach to the male portion 206 of the adaptor 220. In some embodiments, the interior surface of the hollow shaft 340 as well as the exterior surface of the male portion 206 include interference surfaces, such as threads that allow for the adaptor butt 210 and the adaptor 220 to be selectively secured together (e.g., screwed together). Such a configuration facilitates the installation and/or removal of the grip portion 200 from the shaft 240. However, other configurations, such as friction fit, may also be used to achieve the same utility.

The adaptor butt 210 also includes an outer diameter that, in some embodiments, is configured to correspond to the proximal end of the grip portion 200. In some embodiments, the adaptor butt 210 includes a recessed area 360 to receive the proximal end of grip portion 200. In some embodiments, the adaptor butt 210 may be adhered to the grip portion 200 using an adhesive material. In some embodiments, the proximal end of grip portion 200 has a stepped configuration, which may be achieved by any number of methods, such as heat compression, exposing a portion of the underlying mounting tube, etc. For example, heat compression may be used to compress a width of the proximal end that is equal to the depth of recessed area 360. In this way, a smooth and substantially unitary appearance may be achieved at the juncture between grip portion 200 and adaptor butt 210.

In some embodiments, one or more adaptor pieces do not include a recessed area. For example, the domed, rounded, or curved portion of adaptor butt 210 may include a planar region substantially orthogonal to the hollow cylindrical body shaft 340. In such a configuration, the proximal end of the grip portion 200 may include a similarly planar surface that abuts the planar surface of the adaptor butt 210. A similar arrangement may also be achieved for the distal cap 230. Such planar surfaces can be seen, for example, in FIGS. 2 and 6.

FIGS. 3 and 6 demonstrate that the adaptor butt 210 may exhibit any number of desirable profiles or shapes, which may depend on any number of factors, such as the shape of the grip portion 200, customer preferences, etc.

The grip portion 200 shown in FIGS. 1-3 is merely exemplary as other shapes and sizes could be used. For example, in some embodiments, the grip portion 200 may exhibit a more curved profile from a side perspective. In some embodiments, at least one side of the grip portion 200 may even be substantially flat. According to some embodiments, the grip portion 200 is sized to fit any number of different fishing poles. Moreover, in some embodiments, any one or more of the distal cap 230, the adaptor 220, or the adaptor butt 210 may be sized to correspond to the particular fishing pole for which a replacement grip assembly 100 is desired.

In some cases, a fishing pole may have a smaller grip area. This may become a problem if a replacement grip is larger than the original, factory-installed grip. However, this problem can be remedied by selecting appropriately sized grip assembly pieces. For example, an adaptor 220 and/or an adaptor butt 210 may be chosen that have longer hollow shaft portions, thereby effectively extending the available length of the shaft 240. Thus, a shorter grip may be replaced with a longer grip. Of course, in some embodiments, a shorter grip replacement could be used, thereby not necessitating longer assembly pieces. Additionally, because of the variable positioning of distal cap 230, a replacement grip could be shorter than the original, factory-installed grip.

Referring now to FIG. 7, another embodiment of a replaceable grip assembly 700 is shown attached to a shaft of a telescoping fishing pole TP, such as a Tenkara pole or Tai pole. The telescoping pole TP generally does not include line guides or rings for receiving fishing line.

A telescoping pole TP is a telescoping pole in which the base portion 710, or the portion that includes the replaceable grip assembly 700, is configured to contain all the telescoping elements 720 of the pole. Additionally, such poles are generally long so that all or virtually all of the interior space of the base portion 710 is needed to accommodate the telescoping elements 720. The number of telescoping elements 720 may depend on the specific pole and the extended length of the pole. Generally, however, the base portion 710 may be configured to accommodate all of the telescoping elements 720 irrespective of the number. In some embodiments, the number of telescoping elements 720 is between five and ten, and some embodiments have seven telescoping elements 720

Accordingly, and as illustrated in FIG. 8, the replaceable grip assembly 700 includes an adaptor extension 800 configured to mate or attach to both the adaptor 810 and the adaptor butt 820. Distal cap 830 can be configured to slide onto the shaft or base portion 710 of the telescoping pole TP followed by the grip portion 850 and then the adaptor 810, the adaptor extension 800, and the adaptor butt 820. However, in some embodiments, the adaptor 810 may be secured to the shaft 710 before positioning the grip portion 850 on the shaft 710. Further, in some embodiments, both the adaptor 810 and the adaptor extension 800 may be secured to the proximal end of the shaft 710 prior to positioning the grip portion 850 on the shaft 710.

Because of the tapered nature of many shafts, such as shaft 710, and the positioning of the distal cap 830 at a point distal to the widest portion of the shaft 710, there may be a gap (not shown) between the inner surface of a hollow shaft portion of the distal cap 830 and the outer surface of the shaft 710. Such a gap may be left open or may be filled with a suitable material, such as an adhesive or a rubber material. If the gap is not filled, it may be desirable to adhere the distal cap 830 to the grip portion 850. Because of the telescoping nature of the pole TP, in some embodiments, the distal cap 830 may be slipped over the distal end of the pole TP and, thus, may be configured to frictionally engage the base portion 710 and have an interior diameter that is not large enough to pass all the way along base portion 710.

As mentioned above, some embodiments of a grip portion include a gripping material that is spiral wrapped around a mounting tube while some embodiments include a panel wrapped around a mounting tube. Grip portion 850 includes a spiral wrapped material 860 on a mounting tube 870. However, other configurations may be used, such combinations of spiral wraps and panel wraps or sectioned panel wraps, both of which may be used to incorporate more than one material.

As with the embodiment illustrated in FIG. 2, the embodiment illustrated in FIG. 8 can be described in terms of ratios between the respective lengths of various components, for example the length 804 of the male portion 806 of the adaptor butt 820, the length 808 of the adaptor extension 800, the length 812 of the male portion 814 of the adaptor 810, and the length 816 of the hollow shaft portion 818 of the adaptor 810. In some embodiments, the ratio between lengths 804 and 808 is about 1:2. In some embodiments the ratio between lengths 804 and 808 may be from about 1:7 to about 4:5. In some embodiments, the ratio between lengths 812 and 808 could be about 1:2. In some embodiments, the ratio between lengths 812 and 808 may be from about 1:5 to about 4:5. And the ratio between lengths 812 and 816 may be about 1:3. In some embodiments the ratio between lengths 812 and 816 may be from about 1:10 to about 3:2. In some embodiments, the ratio between lengths 816 and 808 may be about 7:5. In some embodiments, the ratio between lengths 816 and 808 may be from about 1:4 to about 5:1. In some embodiments, the ratio between the length of the grip portion 850 and length 808 may be about 9:1. And in some embodiments, the ratio between the length of the grip portion 850 and length 808 may be from about 7:2 to about 30:1.

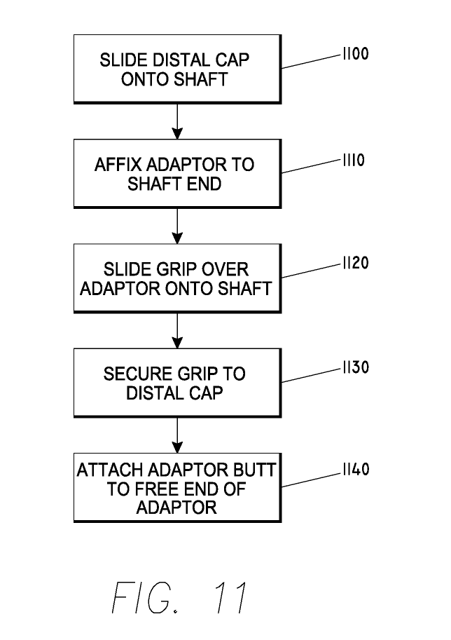

As shown in FIGS. 8 and 9, the adaptor extension 800 includes a hollow shaft 802 running the length of the adaptor extension 800. Both ends of the adaptor extension 800 are configured to mate or attach to the adaptor butt 820 and the adaptor 810, respectively. In some embodiments, both the proximal and distal ends of the adaptor extension 800 include thread elements to allow the adaptor extension 800 to be screwed in place. The interior diameter of the hollow shaft 802, in some embodiments, is configured to be large enough to accept one or more of the telescoping elements 720 of the telescoping pole TP.

The adaptor extension 800 further includes a proximal end and a distal end. In some embodiments, the adaptor extension 800 may include two male ends, two female ends, or a male and a female end. The illustrated adaptor extension 800 includes two female ends and is configured to receive respective male portions on both the adaptor butt 820 and the adaptor 810. FIG. 9 further illustrates that the hollow shaft 802 is in communication with the interior volume of the base portion 710 so as to receive one or more of the telescoping elements 720 of the telescoping pole TP. In some embodiments, the hollow shaft 802 is configured to allow access to the telescoping elements 720 such that the installation of a replacement grip assembly continues to allow access to the telescoping elements 720 should they need maintenance or to be replaced or repaired.

Also illustrated in FIG. 9 is that some embodiments include recessed areas 910 and 920, respectively, in one or both of adaptor extension 800 and distal cap 830 for accepting or accommodating respective ends of grip portion 850. In other words, recessed area 910 may be configured to accept the proximal end of grip portion 850. And recessed area 920 may be configured to accept the distal end of grip portion 850. In such a configuration, one or both the distal and the proximal ends of grip portion 850 may include a stepped configuration, which may be achieved by any number of methods, such as heat compression, exposing a portion of the underlying mounting tube, etc. For example, heat compression may be used to compress a width of the proximal end that is equal to the depth of recessed area 920. In this way, a substantially smooth and/or substantially unitary appearance may be achieved at the juncture between grip portion 850 and adaptor extension 800. Similarly, a substantially smooth and/or substantially unitary appearance can be achieved at the juncture between the distal end of grip portion 850 and distal cap 830.

According to some embodiments, the amount of insertion or the amount that a recessed area extends along a length of grip portion 850 may vary depending on the process used to accommodate the recess, the materials used for grip portion 850, the materials used for the grip assembly, etc. This feature may also be called a recessed depth. The recessed depth of recessed area 910 may be greater than about 1 millimeter. In some embodiments, recessed area 910 may be less than about 1 centimeter in depth. In some embodiments, the depth of recessed area 910 may be from about 1 millimeter to about 3 millimeters. In some embodiments, the depth is about 2 millimeters.

Similarly, the recess depth of recessed area 920 may be greater than about 1 millimeter. In some embodiments, recessed area 920 may be less than about 1 centimeter in depth. In some embodiments, the value may be from about 1 millimeter to about 3 millimeters. In some embodiments, the recessed depth is about 2 millimeters.

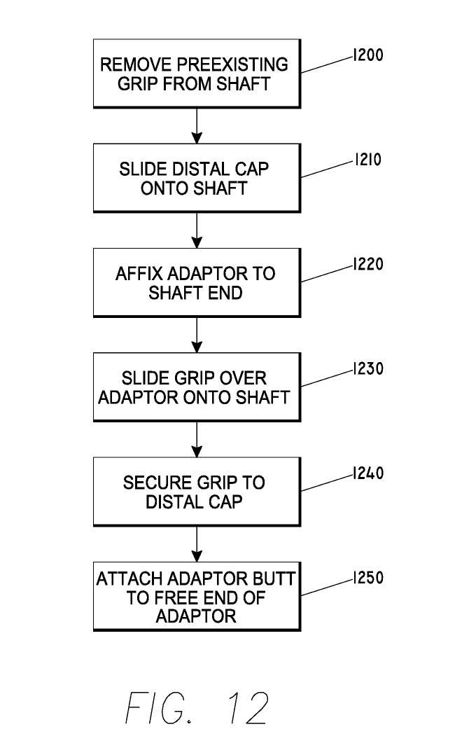

FIG. 10 illustrates an enlarged sectioned view of the telescoping pole TP with the various telescoping elements 720 extending through the hollow portions of adaptor 810 as well inside the hollow shaft 802 of adaptor extension 800.

As discussed above with respect to the other elements of a replaceable grip assembly 700, the adaptor extension 800 may be sized to accommodate different sized poles or different sized grip portions 850. Thus, if a longer grip portion 850 is desired, a longer adaptor extension 800 could be used to accommodate the additional length of the grip portion 850. Alternatively, if a shorter grip portion 850 is desired, the adaptor extension 800 may be omitted from the configuration so that only the adaptor butt 820 is attached to the adaptor 810.

The adaptor pieces (which can include one or more of a distal cap 230 or 830, an adaptor 220 or 810, an adaptor extension 800, and an adaptor butt 210 or 820) may be provided as a kit configured to facilitate the replacement of a grip on a rod such as a fishing pole. A kit of adaptor pieces may further include a replacement grip, such as the illustrated grip portion 200 or 850. In some embodiments, a kit of adaptor pieces includes instructions for removing a prior grip and properly installing the various adaptor pieces as well as installing and securing a replacement grip.

In some embodiments, an adaptor and adaptor butt as well as, in some cases, an adaptor extension, such as those shown in FIGS. 2 and 3 as well as those shown in FIGS. 8 and 9 may comprise materials able to withstand the forces normally applied to the handle of an article, such as a fishing pole. Thus, in addition to extending the effective length of a fishing pole, the assembly pieces may also enhance the support provided to the grip.

According some embodiments, a method for the installation of the adaptor pieces and a grip or a replacement grip proceeds according to the process outlined in FIG. 11, although a skilled artisan would recognize that some of the steps may be omitted or performed in a different order, and additional steps may be included. FIG. 11 illustrates an installation method in which a distal cap, for example distal cap 230 or 830, is first slid onto the shaft of a rod, such as a fishing rod, at step 1100. An adaptor may then be secured to a proximal end of the shaft at step 1110. A grip portion, such as the grip portions 200 or 850, is then slid over the adaptor and onto the shaft at step 1120. In some embodiments, the replacement grip portion is slid onto the shaft before securing the adaptor to the proximal end of the shaft such that step 1120 is performed before step 1110. It may be desirable in some embodiments to secure the adaptor to the proximal end of the shaft with an adhesive.

With the replacement grip on the shaft, the distal end of the grip is secured to the distal cap at step 1130. Securing the grip to the distal cap may involve the use of an adhesive applied between the respective surfaces of the grip and the distal cap. In some embodiments, the distal cap is configured to receive a distal end of the grip. The distal cap and/or the grip may be secured to the shaft using, for example, an adhesive. With the grip and the adaptor on the shaft, an adaptor butt is then secured to the adaptor at step 1140.

An adhesive may be used to further secure the adaptor butt to the adaptor. However, some embodiments involve the use of interlocking connections, such as threaded interfaces and/or friction fits, to secure the various pieces to each other so as to eliminate or reduce the need for adhesives.

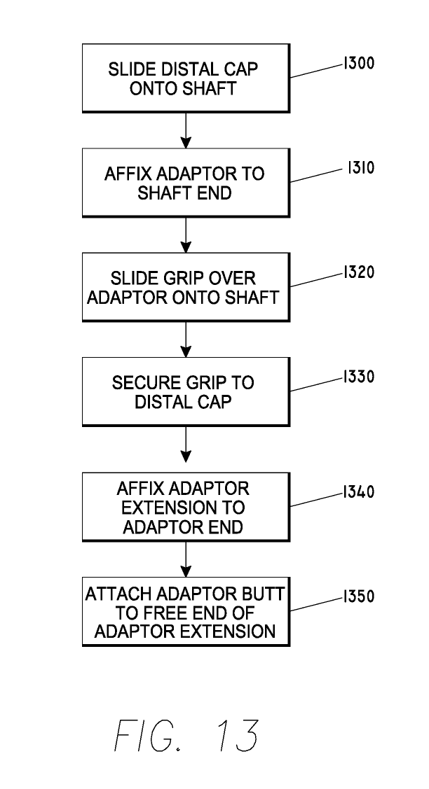

FIG. 12 illustrates an embodiment of a method for replacing a grip on the shaft of a rod, such as fishing rod or pole. At step 1200 the preexisting grip is removed from the shaft. This may be accomplished in any number of ways; however, simply cutting the grip may prove to be the easiest method.

A distal cap can then be slipped onto the shaft at step 1210. In some embodiments, it may be desirable to slide a variety of distinct distal caps onto the shaft to determine which distal cap functions the best (which may depend on other elements already on the shaft, such as a finger hook) or is aesthetically most pleasing on the shaft.

An adaptor is then affixed or secured at step 1220 to the proximal end of the shaft. Depending on the nature of the shaft end it may be desirable to prepare the shaft end. For example, in some embodiments, the shaft end is ground down to receive the adaptor. Grinding the exterior circumference of the shaft may also facilitate a frictional force between the shaft and the adaptor as well as any adhesive that may be used.

Either before or after affixing the adaptor, a replacement grip portion is slid onto the shaft at step 1230. With the grip on the shaft, the distal end of the grip is then secured to the distal cap at step 1240. Adhesives may be used to secure the two elements; however, frictional forces may suffice to secure the distal cap to the grip. In some embodiments, such as the embodiment illustrated in FIG. 4, it may not be necessary to secure the distal cap as it is held in place between the grip and an element on the shaft, such as the illustrated finger hook. According to some embodiments, such as the one shown in FIG. 5, a distal cap is omitted, and the grip is secured or positioned proximal to an element on the shaft. In such embodiments, the grip may be adhered to the shaft element and/or to the shaft itself. Alternatively, it is not so secured. With the grip and adaptor in place, an adaptor butt is secured to the adaptor at step 1250.

According to some methods, such as the one shown in FIG. 13, an adaptor extension is secured between an adaptor and an adaptor butt. A distal cap is slid onto a shaft at step 1300, followed by an adaptor at step 1310 and a grip at step 1208—though, in some embodiments, step 1208 may precede step 1310. The grip is then secured to the distal cap at step 1206. With the grip on the shaft, it may then be possible to determine if an adaptor extension is necessary (such as where a replacement grip is larger than the available space on a fishing pole shaft) and, if so, what size it should be. For example, where a significant portion of the grip extends beyond the end of the installed adaptor a longer adaptor extension may be desired. Where less of the grip extends beyond the end, a short adaptor extension may be desired. And in some embodiments, there may be an insufficient length of the grip extending beyond the adaptor if at all to necessitate an adaptor extension. With the appropriate size selected, the adaptor extension is secured to the adaptor at step 1340. The adaptor butt is then secured to the adaptor extension at step 1350.

Advantageously, embodiments of the present replaceable grip assembly permit a grip to be slid onto an article and later adjusted such that various features are displayed or oriented in a desirable fashion. Later attachment of the adaptor butt and/or adaptor and/or application of adhesive, such as at the distal or proximal ends of the grip portion, allow the orientation to be substantially fixed. Thus, a particular pattern or logo, etc. can be desirably located or positioned. Similarly, more durable portions of the grip, if incorporated, can be properly aligned to correspond to areas of high wear.

Referring back to FIG. 2, there is illustrated an exploded view of a grip assembly according to some embodiments. The grip portion 200 includes a cavity configured to receive at least a portion of the handle portion or shaft 240 of a fishing pole or other article. A mounting surface or mounting tube 260 extends between the first and second ends of the grip portion 200.

In some embodiments, the distal end of the grip portion 200 may include a nipple (not shown), which in some embodiments is a stepped structure configured to accommodate a finger hook FH of a fishing pole FP. Alternatively, in some embodiments the nipple may be tapered to provide a smoother transition from the smaller diameter exposed handle, rod, or shaft 240 near the nipple to the grip portion 200. The nipple may be integrally formed with the mounting tube 260 surface or may be separately formed and later joined to the mounting tube 260. In some embodiments, the nipple may define a circumferential nipple ledge extending around the grip portion 200 and extending radially outward from the mounting tube 260 of the grip portion 200 adjacent the mounting tube 260. The nipple ledge may comprise a nipple contact surface and a nipple outer surface.

A method of manufacturing a grip portion will now be described; however additional manufacturing details can be found in U.S. Patent Publication 2010/0260987, the entirety of which is incorporated herein by reference. In some embodiments, a block of ethylene-vinyl-acetate (EVA) is mounted on a support rod to facilitate a grinding process. A grinder shaped to impart a desired configuration is brought into contact with the block of EVA. As the block makes contact with the grinder, the general shape of the grip component is formed. The same grinder that forms the mounting surface or body of the grip portion 200 may also shape the nipple if so included. Alternatively, this portion of the grip portion 200 is formed by one or more additional grinders of appropriate shape.

In some embodiments, once the shape of the grip portion 200 is completed, the mounting rod is preferably removed. In some embodiments, the mounting rod has an external diameter generally equal to the external diameter of the handle portion of an article intended to be inserted into the grip portion 200.

FIG. 2 illustrates a sheet material 250 shaped to generally correspond with the mounting tube 260 surface of the grip portion 200 when applied thereto. Shown as a panel, the illustrated embodiment is folded or wrapped around the mounting tube 260 surface to form a substantially vertical seam that joins the side edges of the panel as described in greater detail below. Alternatively, the sheet material 250 could be formed as a strip that would in turn be spirally wrapped around the mounting tube 260. In some embodiments, multiple panels and/or strips may be incorporated.

In some embodiments, the sheet material 250 preferably includes an outer layer adhered, bonded, glued or otherwise attached to a base or inner layer. The outer layer defines an inner surface and an outer surface. Similarly, the inner layer defines an inner surface and an outer surface. In some embodiments, a spray on adhesive is applied to one or both of the inner surface of the outer layer and/or the outer surface of the inner layer. In some embodiments, the inner layer comprises EVA to reduce the weight and lower the density of the finished grip portion 200 and to provide a cushioning material that is less inclined to absorb and hold water or other fluids. This is particularly useful in fishing pole applications, for example when the pole is dropped into the water, as the lightweight/low density grip according to embodiments of the present invention will preferably float even when wet. In some embodiments, the EVA inner layer is between approximately 0.5 and 1.5 millimeters thick. In some embodiments, the EVA inner layer is between approximately 0.75 and 1.25 millimeters thick. In a preferred embodiment, the EVA inner layer is approximately 1 millimeter thick.

As described in greater detail below, the outer layer preferably includes a thin non-woven fabric layer that is saturated with polyurethane, by, for example, dipping the thin fabric layer into a polyurethane bath. The polyurethane is preferably coagulated to form one or more closed cells or pores. The non-woven fabric layer has an outer surface and an inner surface and may be fabricated of suitable materials such as nylon, cotton, polyester, or the like and may be felt. The fabric layer is preferably compressed reduce its thickness prior to the application of polyurethane thereto. In some embodiments, the compression also enhances the rigidity of the fabric layer. In some embodiments the compression also spreads the non-woven fibers to enhance the penetration of the polyurethane into the thin fabric layer. Increasing the amount of polyurethane penetration and saturation into the thin fabric layer reduces the amount of space available for water and other fluids to soak into and become trapped within the gripping member. This is particularly useful in fishing pole applications. In some embodiments, the thin non-woven fabric layer is between approximately 0.1 and 0.5 millimeters. In some embodiments, the thin non-woven fabric layer is between approximately 0.3 and 0.4 millimeters thick. In some embodiments, the thin non-woven fabric layer is between approximately 0.3 and 0.35 millimeters thick. In a preferred embodiment, the thin fabric layer is approximately 0.35 millimeters thick.

In some embodiments, the thin fabric layer is coated with and saturated by polyurethane. In some embodiments, the polyurethane coating the thin fabric layer is between approximately 0.1 and 0.4 millimeters thick measured from the outer surface of the fabric layer. In some embodiments, the polyurethane coating the thin fabric layer is between approximately 0.15 and 0.25 millimeters thick. In a preferred embodiment, the polyurethane coating the thin fabric layer is approximately 0.2 millimeters thick.

Embodiments of the present invention provide a lightweight/low density grip with sufficient torsion resistance for use with a variety of articles including fishing rods and golf clubs. In some embodiments, a finished sheet material 250 including a combined polyurethane/thin fabric layer adhered to an EVA base layer weighs between approximately 5.0 and 6.0 grams. In a preferred embodiment, the sheet material 250 weighs approximately 5.3 grams while still providing the sensitive vibration feel and structural benefits to be able to float on water even when wet.

In some embodiments, an additional woven fabric mesh is included in the polyurethane layer during the manufacturing process. In some embodiments, the fabric mesh is attached to the thin non-woven fabric layer prior to dipping in the polyurethane bath. For example, the fabric mesh can be stitched to an end of the thin fabric layer and the combination dipped into a polyurethane bath. An example of the dipping process is described in greater detail below. The woven fabric mesh generally does not absorb the polyurethane during the preparation process. In some embodiments, the outer layer of the sheet material 250 includes a saturated thin fabric layer and an un-saturated fabric mesh layer. In some embodiments, the fabric mesh includes longitudinally extending fibers (fibers that extend generally along the length of the long axis of a grip or along the long axis of a strip is the finished grip is formed from a spirally wrapped strip) and transversely extending fibers. In some embodiments, the longitudinally extending fibers will preferably be of a larger diameter than the transversely extending fibers. For example, the longitudinal fibers may have a diameter between approximately 0.4 and 0.75 millimeters and the transverse fibers may have a diameter between approximately 0.25 and 0.5 millimeters. In some embodiments, the longitudinal and transverse fibers may be of substantially equal diameters. The woven fabric mesh may be fabricated of suitable materials such as nylon, cotton, polyester, or the like.

Generally, in some embodiments, a thin non-woven fabric is dipped into a polyurethane bath. In some embodiments, the bath is a solution of polyurethane (e.g., polyester, polyether) dissolved in dimethylformamide (DMF). The solids content of the polyurethane will vary in accordance with the desired hardness of such polyurethane. A preferred solids content solution is approximately 28.5-30.5%, with a viscosity range of about 60,000-90,000 cps measured at 25.+/−.0.5 degrees C. The viscosity of the polyurethane bath can be manipulated to control the thickness of the polyurethane that ultimately collects on the fabric. The polyurethane preferably coats both sides of the sheet fabric sheet and saturates through the sheet fabric sheet.

In some embodiments, additional liquid polyurethane can be added to the top surface of the uncoagulated polyurethane that coats the thin fabric after the sheet is directed out of the polyurethane bath. The second polyurethane can include one or more different characteristics from the polyurethane in the bath to provide contrast on the sheet material 250. For example, the second polyurethane can include a different color, durometer or level of tackiness.

In some embodiments, the fabric/polyurethane sheet is directed out of the polyurethane bath and into a first processing stage in which a portion of the polyurethane is removed from the bottom of the fabric. In some embodiments, a majority of the polyurethane is removed. In addition, the top surface of the polyurethane is preferably smoothed. In some embodiments, the processing stage occurs in a compression system comprising a pair of rollers. The spacing of the rollers can be used to help determine the thickness of the polyurethane coating the fabric. In some embodiments, the bottom roller includes a rubber surface or a surface comprising another similar resilient material. The bottom roller preferably removes a portion of the polyurethane and in some embodiments the majority of the polyurethane from the bottom of the fabric. In some embodiments, the bottom roller can be substituted with any other similar apparatus which strips off polyurethane from the bottom of the fabric. For example, a non-rotating edge may be used. In some embodiments, the top roller includes a stainless steel surface or a surface comprising another similar smooth, hard surface. The top roller preferably smoothes the top surface of the polyurethane that coats the fabric.

When a wet coagulation process is used, the saturated and coated fabric sheet is then preferably directed into one or more water baths to displace the DMF from the polyurethane and to facilitate the formation of pores in the polyurethane. From the water bath, the coagulated polyurethane sheet is preferably directed to another processing stage to press water and DMF from the coagulated polyurethane sheet. In some embodiments, the processing stage includes one or more pairs of rollers.

As described above, the non-woven sheet is preferably compressed prior to being dipped. The compression process can add rigidity to the sheet and can open or enhance random holes in the sheet. These holes facilitate the saturation of polyurethane into and through the fabric during the dipping and coagulation process.

The polyurethane preferably coats both sides of the fabric and penetrates through the sheet. The non-woven fabric generally includes holes that allow portions of the polyurethane to extend from the top surface of the polyurethane coating the fabric to the bottom surface of the saturated sheet of fabric.

The coagulation process generally allows the polyurethane to expand and increase in thickness. In addition, pores preferably form within the polyurethane and can enhance features of the grip portion including tackiness of the sheet material 250.

In some embodiments, the polyurethane coating the top or outer surface of the fabric defines an outer surface. Similarly, the polyurethane coating the bottom or inner surface of the fabric defines an inner surface. The polyurethane defines a first thickness between the outer surface of the polyurethane and the outer surface or plane of the fabric. The polyurethane defines a second thickness between the inner surface of the polyurethane and the inner surface of the sheet. In some embodiments, the first thickness is substantially greater than the second thickness. In some embodiments, the first thickness is between approximately 2 and 50 times as thick as the second thickness. In some embodiments, the first thickness is between approximately 10 and 15 times as thick as the second thickness. In some embodiments, the second thickness is approximately zero.

The generally smooth surface of the coagulated polyurethane forming the outer surface of the outer layer can be further manipulated, such as, for example, by using a heated mold or platen to form a friction enhancing pattern thereon or to imprint logos or other indicia. FIG. 2 illustrates one such pattern 204 that could be repeated over at least some of the surface of the outer layer. In addition, the surface can include printed materials as known to those of skill in the art. In some embodiments, the bottom surface includes both fabric fibers from the thin non-woven fabric as well as polyurethane. The bottom surface is preferably rougher than the smooth top surface which can facilitate bonding, adhering, or otherwise joining the polyurethane/felt sheet to its EVA inner layer as described in greater detail below according to some embodiments. In some embodiments, a portion of polyurethane remains on the bottom or inner surface of the fabric after the treatments described above. In some embodiments, the fabric is discernible through at least a portion of the polyurethane remaining on the inner surface.

The polyurethane/felt sheet described above is preferably bonded to an EVA inner or base layer. The EVA inner layer may be covered by an adhesive upper layer and protective tape according to some embodiments. Suitable EVA sheets are available from the Ho Ya Electric Bond Factory, Xin Xing Ind. Area. Xin Feng W. Rd., Shi Jie Town Dong Guan City, Guan Dong, Province, China. In some embodiments, the EVA sheet includes an adhesive that is covered with a protective sheet. The sheet is removed prior to bringing the EVA sheet into contact with the bottom side of the polyurethane/felt sheet. Alternatively, adhesive can be sprayed or otherwise applied to one or both of the bottom side of the polyurethane/felt sheet and/or the EVA sheet. The finished sheet can then be wound onto to a spool to wait for further processing. Alternatively, it can be directed to another location for continuous further processing.

In some embodiments, the polyurethane/felt sheet is glued to the EVA inner layer. Once formed, the polyurethane/felt/EVA sheet can be cut into any suitable shape, such as a panel. A panel generally includes first and second side edges and top and bottom edges. A mold can be used to form a friction enhancing pattern on the top surface of the polyurethane/felt/EVA sheet. Skiving tools can be used to form skived edges on the sheet. In some embodiments, the first and second side edges can be skived through one or more layers of the panel. In the illustrated embodiment, the skiving extends through at least a portion of all of the layers of the panel. In some embodiments, the side edges are skived in a parallel fashion such that, when wrapped around the mounting surface, the edges overlap with like layers in contact with and glued to like layers along an angled seam. In some embodiments, the side edges are skived in an anti-parallel fashion such that, when wrapped around the mounting surface, the seam can be stitched with the outer surfaces at or near the side edges contacting each other.

To apply the sheet material 250 onto the mounting tube 260, an adhesive may be sprayed onto the mounting surface of the grip portion 200, the inner surface of the sheet material 250 or both as shown and the panel is wrapped around the mounting surface. As mentioned above, the side edges of the panel can be skived so as to overlap along the seam with like layers generally contacting like layers. Alternatively, the side edges can be skived such that the outer surface of the panel at or near the side edges contact each other along the seam. In some embodiments, such a seam is stitched closed with the stitches preferably extending through the polyurethane/felt layer and the EVA inner layer. In some embodiments, the stitching only extends through the polyurethane/felt layer. In some embodiments, the panel is stitched inside out with the polyurethane surface facing inwards and, after stitching the seam, the panel is reversed as it is applied to the grip portion 200 such that, on the finished grip portion 200, the polyurethane surface is outward facing.

In some embodiments, the EVA grip portion 200 is injection molded rather than ground down from a block of EVA foam. Ethylene vinyl acetate copolymers possess many excellent characteristics such as low weight, low density, flexibility, transparency, non-toxicity and good resistance to environmental stress cracking, etc. Some embodiments of the present invention overcome the difficulties of working with injection molded EVA. For example, EVA coagulation is a relatively slow process. After injection molding a rough EVA sleeve, a core bar can be inserted inside the grip portion 200 and the grip portion 200 can be transferred to an appropriate mold to control the shape of the finished product. Controlling temperature and time facilitates effective control of the EVA coagulation. In some embodiments, the density of the EVA included in the sleeve is less than approximately 1 g/cm³. In some embodiments, the density is between approximately 0.9 and 1 g/cm³. In a preferred embodiment, the density is between approximately 0.930 and 0.943 g/cm³. Controlling the degree of coagulation of the EVA allows embodiments of the invention to include an EVA sleeve whose volume is, for example, approximately doubled or tripled from the original volume. Therefore, in some embodiments, the density of the finished grip portion 200 can be approximately one half or one third of the original density.

One or more aspects of each of the embodiments described herein can be combined with one or more aspects of other embodiments and such combinations are specifically contemplated herein. Further, general modifications of the disclosure are also contemplated.

What is claimed is:

1. A grip assembly for the handle portion of an article, the grip assembly comprising:
a grip portion generally defined by a hollow interior shaft open at both a proximal end and a distal end of the grip portion;
an adaptor configured to secure, at a distal end of the adaptor, to a proximal end of a shaft of the handle portion; and
an adaptor butt configured to engage a proximal end of the adaptor, the adaptor butt further configured to engage the proximal end of the grip portion.

2. The grip assembly of claim 1, further comprising an adhesive, wherein the adhesive is used to secure the adaptor to the proximal end of the shaft.

3. The grip assembly of claim 1, further comprising threads on at least one of said adaptor butt and said adaptor, wherein a threaded engagement is used to engage the adaptor butt to the adaptor.

4. The grip assembly of claim 1, wherein the distal end of the grip portion is configured to engage an element on the handle portion of the article.

5. The grip assembly of claim 4, wherein the distal end of the grip includes a stepped configuration insertable within an end of the element on the handle portion of the article.

6. The grip assembly of claim 4, wherein the element on the handle portion of the article is a finger hook.

7. The grip assembly of claim 1, further comprising a distal cap having a hollow shaft portion and an exterior portion configured to engage the distal end of the grip portion

8. The grip assembly of claim 7, where the distal cap is shaped to provide a smooth transition between the handle and the distal end of the grip portion.

9. The grip assembly of claim 8, wherein the smooth transition comprises a sloped configuration in the general shape of a frustoconical cone.

10. The grip assembly of claim 8, wherein the smooth transition comprises a cylindrical configuration configured to further engage with an element on the handle portion.

11. The grip assembly of claim 10, wherein the element on the handle portion is a finger hook.

12. A method of installing a grip assembly on a handle portion of an article, the method comprising the steps of:
sliding a grip portion onto a shaft of the handle portion, the grip portion being generally defined by a hollow interior shaft open at both a proximal end and a distal end of the grip portion;
securing an adaptor to a proximal end of the shaft of the handle portion; and
affixing an adaptor butt to a proximal end of the adaptor, the adaptor butt further configured to engage the proximal end of the grip portion.

13. The method of claim 12, further comprising sliding a distal cap onto the shaft of the handle portion and securing the distal end of the grip portion to a proximal end of the distal cap.

14. The method of claim 13, wherein the distal cap is configured to provide a smooth transition between the distal end of the grip portion and the handle portion of the article.

15. The method of claim 12, wherein securing the adaptor to the shaft comprises the use of an adhesive between an interior surface of the adaptor and an exterior surface of the shaft.

16. The method of claim 12, further comprising removing a preexisting grip from the handle portion of the article.

17. A method of installing a grip assembly on a handle portion of an article, the method comprising the steps of:
sliding a grip portion onto a shaft of the handle portion, the grip portion being generally defined by a hollow interior shaft open at both a proximal end and a distal end of the grip portion;
securing an adaptor to a proximal end of the shaft of the handle portion, the adaptor portion being defined by a hollow interior shaft open at both a proximal end and a distal end of the adaptor;
affixing an adaptor extension to the proximal end of the adaptor, the adaptor extension being defined by a hollow interior shaft open at both a proximal end and a distal end; and
affixing an adaptor butt to the proximal end of the adaptor extension, the adaptor butt further configured to engage the proximal end of the grip portion.

18. The method of claim 17, further comprising sliding a distal cap onto the shaft of the handle portion and securing the distal end of the grip portion to a proximal end of the distal cap.

19. The method of claim 18, wherein the distal cap is configured to provide a smooth transition between the distal end of the grip portion and the handle portion of the article.

20. The method of claim 17, wherein securing the adaptor to the shaft comprises the use of an adhesive between an interior surface of the adaptor and an exterior surface of the shaft.

21. The method of claim 17, further comprising removing a preexisting grip from the handle portion of the article.

22. The method of claim 17, wherein the size of the adaptor extension is determined based on the size of the grip portion and the size of the handle portion such as a longer adaptor extension is used where the size of the grip portion greatly exceeds the size of the handle portion.

23. The method of claim 17, wherein, the adaptor and adaptor extension each comprise respective hollow interior portions large enough to accommodate one or more telescoping portions contained within the handle portion of the article.
